(19) United States
(12) Patent Application Publication
(10) Pub. No.: US 2013/0198437 A1
(43) Pub. Date: Aug. 1, 2013

(54) MEMORY MANAGEMENT DEVICE AND MEMORY MANAGEMENT METHOD

(71) Applicants: Takashi OMIZO, Kawasaki-shi (JP); Tsutomu OWA, Kawasaki-shi (JP); Atsushi KUNIMATSU, Funabashi-shi (JP); Hiroto NAKAI, Yokohama-shi (JP); Masaki MIYAGAWA, Kawasaki-shi (JP); Reina NISHINO, Yokohama-shi (JP); Hiroyuki SAKAMOTO, Ome-shi (JP)

(72) Inventors: Takashi OMIZO, Kawasaki-shi (JP); Tsutomu OWA, Kawasaki-shi (JP); Atsushi KUNIMATSU, Funabashi-shi (JP); Hiroto NAKAI, Yokohama-shi (JP); Masaki MIYAGAWA, Kawasaki-shi (JP); Reina NISHINO, Yokohama-shi (JP); Hiroyuki SAKAMOTO, Ome-shi (JP)

(21) Appl. No.: 13/560,206

(22) Filed: Jul. 27, 2012

Related U.S. Application Data
(63) Continuation of application No. PCT/JP11/50738, filed on Jan. 18, 2011.

(30) Foreign Application Priority Data
Jan. 27, 2010 (JP) 2010-015866

(51) Int. Cl. G06F 12/02

(52) U.S. Cl. CPC G06F 12/0246
USPC 711/103

(57) ABSTRACT

In an embodiment, a device includes a first unit, a second unit, and a third unit. The first unit generates a write address representing a write position to sequentially store sequential data from a processor to a nonvolatile main memory. The second unit generates order information representing a degree of newness of write. The third unit writes sequentially writes the sequential data at the write address with the order information.

### CROSS REFERENCE TO RELATED APPLICATIONS

This application is a Continuation Application of PCT Application No. PCT/JP2011/050738, filed Jan. 18, 2011 and based upon and claiming the benefit of priority from Japanese Patent Application No. 2010-015866, filed Jan. 27, 2010, the entire contents of all of which are incorporated herein by reference.

### FIELD

Embodiments described herein relate generally to a memory management device for managing access to a memory and a memory management method.

### BACKGROUND

In a conventional information processing device, a volatile semiconductor memory such as a DRAM (Dynamic Random Access Memory) is used as a main memory of the processor. In the conventional information processing device, a secondary storage device is also used in combination with the volatile semiconductor memory.

Since the main memory in the conventional information processing device is a volatile storage device, contents stored in the main memory are lost upon power-off. For this reason, the conventional information processing device needs to start up the system at each boot time. To do this, programs or data need to be loaded from the secondary storage device to the main memory, and a time is taken until execution of processing.

Additionally, in the conventional information processing device, the contents stored in the main memory are not saved upon power-off. For this reason, if the conventional information processing device is not correctly shut down, the data, system, or programs may be destroyed.

### BRIEF DESCRIPTION OF THE DRAWINGS

FIG. 1 is a block diagram showing an example of a detailed arrangement of an information processing device according to a first embodiment.

FIG. 2 is a flowchart showing an example of write back in the information processing device according to the first embodiment.

FIG. 3 is a flowchart showing an example of fetch in the information processing device according to the first embodiment.

FIG. 4 is a flowchart showing an example of restoration processing of the information processing device according to the first embodiment.

FIG. 5 is a flowchart showing an example of entry registration processing of a memory management unit in the information processing device according to the first embodiment.

FIG. 6 is a block diagram showing an example of the information processing device according to the first embodiment in which a normal data storage area and a sequential data storage area are separated.

FIG. 7 is a block diagram showing an example of a nonvolatile main memory according to a second embodiment including a plurality of memory units which are effectively accessed continuously.

FIG. 8 is a block diagram showing a first example of a relationship between a logical data storage position and a physical data storage position in the nonvolatile main memory according to the second embodiment.

FIG. 9 is a block diagram showing a second example of the relationship between the logical data storage position and the physical data storage position in the nonvolatile main memory according to the second embodiment.

FIG. 10 is a block diagram showing a third example of the relationship between the logical data storage position and the physical data storage position in the nonvolatile main memory according to the second embodiment.

FIG. 11 is a block diagram showing an example of an arrangement of an information processing device according to a third embodiment.

FIG. 12 is a block diagram showing an example of ah arrangement of an information processing device according to a fourth embodiment.

FIG. 13 is a block diagram showing an example of a nonvolatile main memory according to a fifth embodiment which stores a program, data, and status information separately in a plurality of data portions (storage areas).

FIG. 14 is a block diagram showing an example of an arrangement of an information processing device according to a sixth embodiment.

FIG. 15 is a block diagram showing an example of an information processing device according to a seventh embodiment including a hybrid memory.

FIG. 16 is a block diagram showing an example of a program and data used in the information processing device according to the seventh embodiment.

### DETAILED DESCRIPTION

The embodiments will now be described with reference to the accompanying drawings. Note that in the following explanation, the same reference numerals denote almost or substantially the same functions and constituent elements, and a description thereof will be made as needed.

### First Embodiment

In this embodiment, a memory management device includes a determination unit, an address generation unit, an order generation unit, and a write control unit. When write data from a processor to a nonvolatile semiconductor memory is generated, the determination unit determines whether the data is sequential data to be continuously accessed or normal data that is not sequential data. When the determination unit determines that the data is normal data, the address generation unit generates a first write address not to make a write position of the normal data overlap a position indicated by another generated address. When the determination unit determines that the data is sequential data, the address generation unit generates a second write address representing a write position to sequentially store the sequential data. The order generation unit generates order information representing a degree of newness of an occurred write. When the address generation unit generates the first write address, the write control unit writes the normal data at the first write address in correspondence with the order information generated by the order generation unit. When the address generation unit generates the second write address, the write control unit sequentially writes the sequential data at the second write address.

An information processing device including the memory management device according to this embodiment uses a nonvolatile semiconductor memory (nonvolatile main memory) as a main memory. The information processing device includes a processor such as an MPU (Micro Processing Unit) and the nonvolatile main memory.

In this embodiment, access to a memory includes at least one of read, write, and erase for the memory.

In this embodiment, data, a program, or a combination of the data and the program is accessed. An example in which data is mainly accessed will be described below for the sake of simplicity.

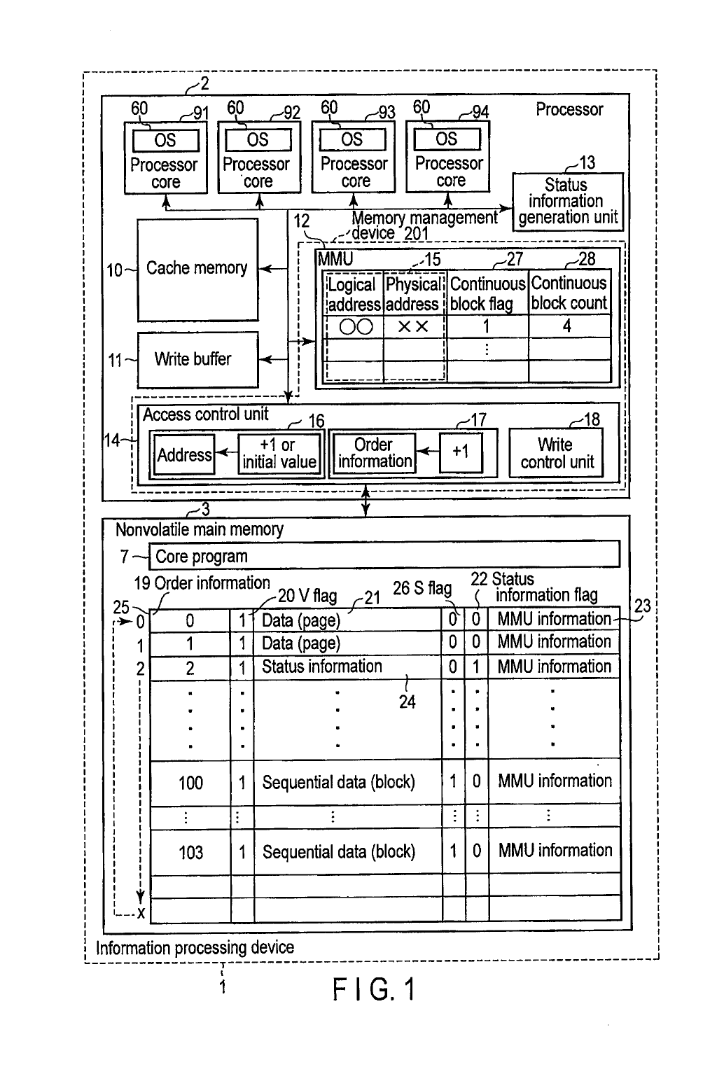

FIG. 1 is a block diagram showing an example of a detailed arrangement of an information processing device according to this embodiment.

An information processing device 1 includes a processor 2 and a nonvolatile main memory 3. The processor 2 can access various kinds of devices such as an external secondary storage device, an external access device, and an I/O device (none are shown). Note that the devices such as an external secondary storage device, an external access device, and an I/O device may be provided as part of the information processing device 1.

As the nonvolatile main memory 3, for example, a flash memory is used. As the flash memory, for example, a NAND or NOR flash memory is applicable. A nonvolatile semiconductor memory such as an PRAM (Phase change memory), an ReRAM (Resistive Random access memory), or an MRAM (Magnetoresistive Random Access Memory) may be used as the nonvolatile main memory 3.

The nonvolatile main memory 3 includes a core program 7 and a data portion 25 serving as the main memory. The data portion 25 includes, for each entry, order information 19, a V flag 20, data 21 or status information 24, a status information flag 22, MMU information 23, and an S flag 26. Details of the arrangement of the data portion 25 will be described later.

The above-described various kinds of data 21 in the nonvolatile main memory 3 is stored in the nonvolatile main memory 3 from, for example, the processor 2 or the external secondary storage device, the external access device, or the I/O device (none are shown).

The processor 2 includes at least one of (four, in the example of FIG. 1) processor cores 91 to 94, a cache memory 10, a write buffer 11, and a memory management unit (MMU) 12. The processor 2 further includes a status information generation unit (for example, PSW control unit) 13 and an access control unit 14.

A memory management device 201 according to this embodiment includes the memory management unit 12 and the access control unit 14. Note that the memory management device 201 may also include the cache memory 10, the write buffer 11, and the like.

The processor cores 91 to 94 execute a program while accessing the cache memory 10 and the nonvolatile main memory 3. The processor cores 91 to 94 can operate in parallel.

The cache memory 10 stores data accessed by the processor cores 91 to 94 for each cache line. A line size of the cache memory 10 equals, for example, a page size that is a data write and read unit of the nonvolatile main memory 3, a multiple of the page size, a block size that is a data erase unit of the nonvolatile main memory 3, or a multiple of the block size. The block size is a data unit corresponding to a multiple of the page size.

An output stage of the cache memory 10 is provided with the write buffer 11. Write target data which is written from the cache memory 10 to the nonvolatile main memory 3 is written to the nonvolatile main memory 3 via the write buffer 11.

The write buffer 11 accumulates write target data from the cache memory 10. When the size of the write target data accumulated in the write buffer 11 has reached a size efficient for write to the nonvolatile main memory 3, the accumulated data is written to the nonvolatile main memory 3.

As described above, in this embodiment, the line size of the cache memory 10 is set to the page size of the nonvolatile main memory 3, a multiple of the page size, the block size, or a multiple of the block size. This allows to raise the efficiency of processing such as data write from the cache memory 10 to the nonvolatile main memory 3 and thus reduce the hardware.

The memory management unit 12 manages address translation information 15 that associates a logical address and a physical address for the cache memory 10 and the nonvolatile main memory 3, a continuous block flag 27, and a continuous block count 28 for each entry. The address translation information 15 is used for translation between the logical address and the physical address.

The status information generation unit 13 obtains status information (for example, PSW: Program Status Word) representing a state of the processor 2 and a state of a program at a predetermined or necessary timing. The status information includes information necessary for restoring an operation state of the processor 2, for example, information of a general-purpose register, a control register, a program counter, and the like. For example, the status information generation unit 13 generates status information every time a predetermined time is elapsed. For example, the status information generation unit 13 generates status information every time write from the processor 2 to the nonvolatile main memory 3 occur a predetermined number of times. Furthermore, the status information generation unit 13 generates status information when a command is received from software such as an operating system 60.

The access control unit 14 controls access between the processor 2 and the nonvolatile main memory 3 such as data write and read between the processor 2 and the nonvolatile main memory 3 and data erase in the nonvolatile main memory 3. In this embodiment, write and read for the nonvolatile main memory 3 are executed on, for example, the page unit, and erase is executed on, for example, the block unit. However, the embodiment is not limited to this, and the write, read, and erase may be done in another data size.

In this embodiment, the access control unit 14 includes an address generation unit 16, an order generation unit 17, and a write control unit 18.

When data write from the processor 2 to the nonvolatile main memory 3 occurs, the address generation unit 16 generates a write address in accordance with a predetermined rule not to make a write position of the write target data overlap a position indicated by another generated address.

As an example of a write address generation method, the address generation unit 16 increments a value of an address serving as a write destination sequentially from a predetermined initial value. When the address reaches a predetermined final value (larger than the initial value), the address generation unit 16 increments the value of the address serving as the write destination sequentially from the predetermined initial value again.

As another example of the write address generation method, the address generation unit 16 decrements the value of the address serving as the write destination sequentially from a predetermined initial value. When the address reaches a predetermined final value (smaller than the initial value), the address generation unit 16 decrements the value of the address serving as the write destination sequentially from the predetermined initial value again.

As still another example of the write address generation method, the address generation unit 16 sequentially generates the value of the address serving as the write destination at several spaces apart (for example, at a predetermined interval) in the first cycle. In the second cycle, the address generation unit 16 sequentially generates the value of the address serving as the write destination in an unused area where no write did in the first cycle. In a similar way, the address generation unit 16 repeats the operation of, in the nth cycle, sequentially generating the value of the address serving as the write destination in an unused area where no write did until the (n−1)th cycle. When the unused area reaches a predetermined value or less, or the unused area reaches a predetermined ratio or less (for example, when no usable unused area remains), the same operation is repeated again from the above-described first cycle.

As yet another example of the write address generation method, the address generation unit 16 refers to the address translation information 15 of the memory management unit 12 and selects and generates an address (physical address) unused in the address translation information 15 as a write address.

Using the above-described write address generation methods enables write with less overlap opportunity between the write position of write target data and the position indicated by the other generated address. Write by an additional write method is executed by an operation of the address generation unit 16. The “additional write” means a method of adding write data.

The order generation unit 17 generates order information to determine the degree of newness of write. Using the order information enables to obtain the latest value of data even if the value of the data is updated by the additional write method. In this embodiment, the order generation unit 17 executes count-up every time write to the nonvolatile main memory 3 occurs, and uses the count value as order information. The order information is stored in the nonvolatile main memory 3 in correspondence with write target data. This allows to determine that data having large order information is the latest data when write concerning data having the same identification information such as a variable name did in a plurality of entries of the nonvolatile main memory 3.

The write control unit 18 controls write processing from the processor 2 to the nonvolatile main memory 3. The nonvolatile main memory 3 manages data on the entry unit, and details will be described later. At the time of write, the write control unit 18 sets the V (Valid) flag 20 of the entry where write target data wrote to “1”. Using the V flag 20 enables to determine whether the entry of the write target is valid or invalid. If the V flag 20 of an entry on the nonvolatile main memory 3 is “1” but it is determined that the entry is not used in the memory management unit 12, the write control unit 18 erases the data stored in the entry and sets the V flag 20 to “0”. When rewriting in the erase-accessed entry, the write control unit 18 performs write again and sets the V flag 20 to “1”.

Upon determining that the V flags 20 of entries in a predetermined number or predetermined ratio or more are “1” (for example, when all V flags 20 are “1”), the write control unit 18 performs exception processing and cleans up unnecessary entries of the nonvolatile main memory 3 by software so as to erase corresponding unnecessary portions and set the V flag 20 to “0”.

In this embodiment, the operating system 60 is stored in at least one of the cache memory 10 and the nonvolatile main memory 3. The processor cores 91 to 94 execute the operating system 60. When data or a program to be written from the processor 2 to the nonvolatile main memory 3 is generated, the operating system 60 that is stored in at least one of the cache memory 10 and the nonvolatile main memory 3 and executed by the processor cores 91 to 94 determines whether the write target data/program is sequential data/program or normal data/program.

Sequential data means a series of data to be continuously accessed. A sequential program means a series of programs to be continuously executed.

An example of sequential data is stream data (video) or log data. Stream data is mainly read out and rarely written. Conversely, log data is continuously written and rarely read out.

Discrimination between stream data and log data is done by the operating system 60. By using a file extension is detected, or when a memory allocated API (Application Program Interface) is called from an application, the data type is designated, thereby discriminating data. Note that if, for example, settings allow to edit stream data, this stream data may not be allocated to the memory as sequential data.

As a sequential data discrimination method, the operating system 60 may detect, based on a past access history, data that is accessed sequentially at high frequency and discriminate a detected data as sequential data.

When sequential data is discriminated, for example, the operating system 60 sets, for the address translation information 15, the continuous block flag 27 corresponding to the detected sequential data to a flag representing sequential data or a sequential program. The continuous block flag 27 represents that a corresponding entry is an entry of a block for storing sequential data.

Normal data and a normal program are data that is not sequential data and a program that is not sequential data, respectively.

A case of sequential data will be described below. A sequential program can also be handled like sequential data.

In this embodiment, an example in which sequential data is managed on the block unit will be explained. This also applies to a case in which sequential data is managed in another size, for example, on the page unit.

When the operating system 60 determines that data to be written is normal data, the address generation unit 16 generates a write address not to make the write position of the normal data overlap the position indicated by the other generated address. When the operating system 60 determines that data to be written is sequential data, the address generation unit 16 generates a write address indicating a write position to sequentially store the sequential data. The address generation unit 16 generates the write address to store the sequential data from the start of a block area. The block area is one area of the memory to store data of the block unit. The block area has an arbitrary size determined by the size of data to be stored on the block unit and has a size of, for example, about 1 MB. The block unit is a unit corresponding to an integer multiple of the page size. When a NAND flash memory is used as the nonvolatile main memory 3, for example, the block unit of the block area of this embodiment may be a so-called “block unit” that is the data erase unit of the NAND flash memory.

When writing write target data to the nonvolatile main memory 3, the write control unit 18 writes the order information (counter value) 19 generated by the order generation unit 17, the V flag 20 “1”, the write target data 21, the status information flag 22 “0”, the MMU information 23, and the S flag 26 “1” or “0” at the position designated by the address generated by the address generation unit 16.

The status information flag 22 is information representing whether the entry is an entry to write status information. For an entry to write status information, the status information flag 22 is set to “1”. For an entry not to write status information, the status information flag 22 is set to “0”.

The MMU information 23 includes various kinds of information managed by the memory management unit 12, for example, the address translation information 15, the continuous block flag 27, and the continuous block count 28.

When the status information generation unit 13 generates new status information, the write control unit 18 writes the generated status information 24 to the nonvolatile main memory 3. When writing the status information 24, the write control unit 18 writes the order information 19 generated by the order generation unit 17, the V flag 20 “1”, the status information 24, the status information flag 22 “1”, the MMU information 23, and the S flag 26 at the position designated by the address generated by the address generation unit 16.

When the address generation unit 16 generates a write address of normal data, the write control unit 18 writes the normal data to the nonvolatile main memory 3 at the position designated by the generated write address in correspondence with order information generated by the order generation unit 17.

When the address generation unit 16 generates a write address of sequential data, the write control unit 18 sequentially writes the sequential data to the nonvolatile main memory 3 at the generated write address in correspondence with order information generated by the order generation unit 17.

In this case, the write control unit 18 continuously writes the sequential data from the start of a block area of the nonvolatile main memory 3 based on the write address of the sequential data.

If the whole sequential data cannot be continuously stored, the write control unit 18 writes the sequential data in a plurality of block areas such that the plurality of block areas are arranged continuously. In addition, the write control unit 18 continuously writes the sequential data in the plurality of block areas.

When continuously writing sequential data from the start of a block area of the nonvolatile main memory 3, the write control unit 18 associates the S flag 26 “1” with the block area of the nonvolatile main memory 3 to store the sequential data. When continuously writing sequential data in a plurality of block areas of the nonvolatile main memory 3, the write control unit 18 associates the S flag 26 “1” with the plurality of block areas of the nonvolatile main memory 3 to continuously write the sequential data.

The S flag 26 is information to determine whether data written to the nonvolatile main memory 3 is sequential data. When the S flag 26 is “1”, it represents that the data is sequential data. When the S flag 26 is “0”, it represents that the data is not sequential data.

When the processor 2 reads out normal data from the nonvolatile main memory 3, the access control unit 14 translates a logical address to a physical address of the nonvolatile main memory 3 based on the address translation information 15 of the memory management unit 12. The access control unit 14 reads out the normal data from the nonvolatile main memory 3 based on the physical address.

When the processor 2 reads out sequential data from the nonvolatile main memory 3, the access control unit 14 translates a logical address to a physical address of the nonvolatile main memory 3 based on the address translation information 15 of the memory management unit 12. Then, the access control unit 14 sequentially reads out the continuously stored sequential data from the position indicated by the physical address of the nonvolatile main memory 3 based on the address translation information 15, the continuous block flag 27, the continuous block count 28, and the S flag 26 in the nonvolatile main memory 3.

An example of sequential data handling by the address translation information 15 according to this embodiment will be described below in more detail.

As described above, the information processing device 1 continuously stores sequential data from the start of a block area as much as possible.

When sequential data is stored in a plurality of continuous block areas from the start of a block area, the S flags concerning the plurality of continuous block areas are set to “1”.

When sequential data is stored in a plurality of continuous block areas, the memory management unit 12 manages the address translation information 15 of the sequential data on the basis of a unit of the plurality of block areas to store the sequential data. As another management method, the memory management unit 12 may manage the address translation information 15 of the sequential data on the page or block unit.

For example, when sequential data is stored in a plurality of continuous block areas, the memory management unit 12 manages the address translation information 15 of the sequential data in one entry. The memory management unit 12 sets the continuous block flag 27 of this entry to “1” and also sets the number (size) of continuous blocks.

The continuous block flag 27 is information to be used to determine whether an entry of the address translation information 15 contains information about a plurality of block areas that store sequential data. When the continuous block flag 27 is “1”, it represents that the entry concerns sequential data. When the continuous block flag 27 is “0”, it represents that the entry concerns data that is not sequential data. The continuous block count 28 represents the number of block areas to continuously store sequential data.

In this embodiment, when, for example, the S flags in the nonvolatile main memory 3 are continuously “1”, the access control unit 14 may determine without using the continuous block count 28 that sequential data is stored in continuous block areas. In this case, however, even when accessing the sequential data from a midpoint, it is necessary to track the sequential data from the beginning.

As described above, when sequential data is stored in a plurality of continuous block areas of the nonvolatile main memory 3, the plurality of block areas of the nonvolatile main memory 3 to store the sequential data are managed in one entry of the address translation information 15, thereby decreasing the use amount (number of entries) of the address translation information 15.

When the continuous block flag 27 of the entry indicated by a logical address in the address translation information 15 is “1”, the access control unit 14 recognizes access to sequential data and recognizes, based on the continuous block count 28, the number of block areas that store the access target sequential data.

Based on the physical address and the continuous block count 28, the access control unit 14 sequentially reads out the sequential data stored in the nonvolatile main memory 3.

In this embodiment, when garbage collection occurs for block areas that continuously store sequential data, the access control unit 14 moves the contents stored in the continuous moving target block areas to other continuous block areas as much as possible.

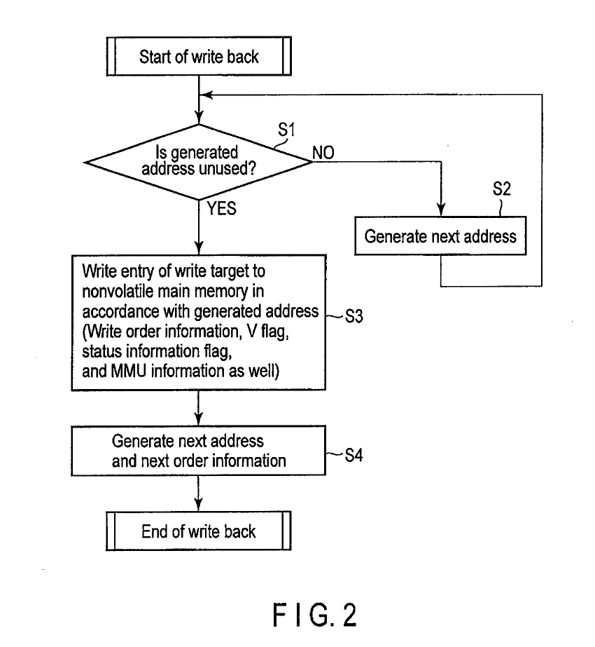

FIG. 2 is a flowchart showing an example of write back in the information processing device 1 according to this embodiment.

Since data in the cache memory 10 are updated by the processor cores 91 to 94, it is necessary to perform write back to write a cache line of the cache memory 10 back to an entry of the nonvolatile main memory 3 as needed or periodically. The processing steps of write back of the information processing device 1 according to this embodiment will be described below. In this embodiment, cache line write to the nonvolatile main memory 3 is done by the additional write method, as described above. For this reason, in the write back of this embodiment, each cache line of the cache memory 10 is written back to a position indicated by an unused address of the nonvolatile main memory 3 generated by the address generation unit 16.

To execute write back, in step S1, the address generation unit 16 of the access control unit 14 determines, by referring to the memory management unit 12, whether a generated address is unused.

If the generated address is being used, in step S2, the address generation unit 16 of the access control unit 14 generates the next address, and the process returns to step S1. In this case, the page that is currently being used is not overwritten by the new page. The write target address on the nonvolatile main memory 3 skips to the address of the next free entry. Note that the next unused address may be detected in advance, instead of obtaining an unused address after the start of write back as in steps S1 and S2.

If the generated address is not being used, in step S3, the write control unit 18 writes the write back target cache line back to the position indicated by the generated unused address of the nonvolatile main memory 3.

At this time, the write control unit 18 updates the address translation information 15 of the memory management unit 12 to represent a status after write back, and writes the current order information 19 and the MMU information 23 including the address translation information 15 of the memory management unit 12 to the nonvolatile main memory 3 for the write back target page. The write control unit 18 also sets the V flag 20 to “1”, the status information flag 22 to “0”, and the S flag 26 to “0”, and writes them to the nonvolatile main memory 3.

The order information 19, the V flag 20, the page 21, the status information flag 22, the MMU information 23, and the S flag 26 are thus written to the position of the nonvolatile main memory 3 indicated by the generated address so that write back is executed.

In step S4 after the write processing of step S3, the address generation unit 16 of the access control unit 14 generates a new address, and the order generation unit 17 generates new order information.

When writing the status information 24 to the nonvolatile main memory 3, if a dirty line exists in the cache memory 10, the dirty line is first written back to the nonvolatile main memory 3. The dirty line means a cache line of the cache memory whose data content is not reflected on the main memory and have no consistency between the main memory and the cache memory.

If an abnormality occurs in a device such as an external secondary storage device, an external access device, or an I/O device, the status information generation unit 13 sets the device in a restorable state by an operation such as SYNC and then generates the status information 24. Then, the write control unit 18 performs write processing of the generated status information 24.

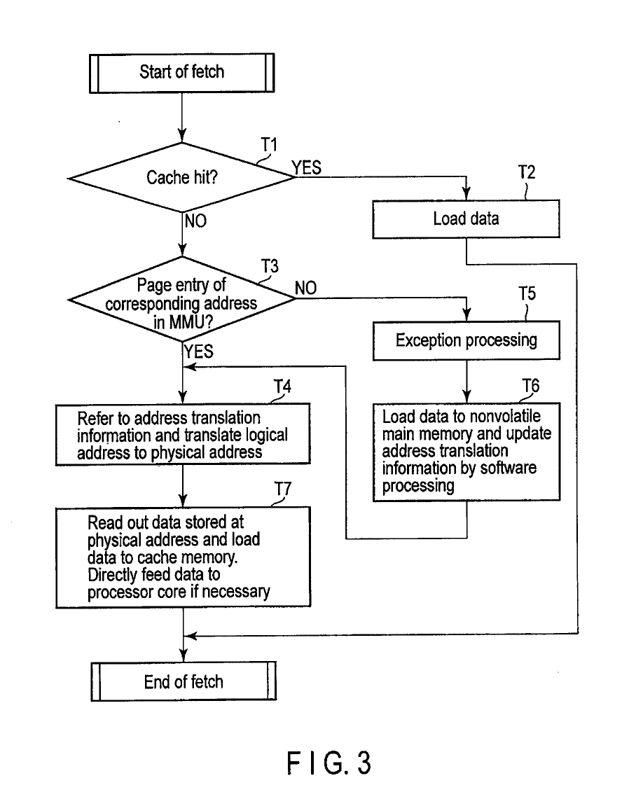

FIG. 3 is a flowchart showing an example of fetch in the information processing device 1 according to this embodiment.

In step T1, the memory management unit 12 determines whether access target data is stored in the cache memory 10 (cache hit).

If the access target data is stored in the cache memory 10, in step T2, the processor cores 91 to 94 load the data on the cache memory 10.

If the access target data is not stored in the cache memory 10, in step T3, the memory management unit 12 determines whether the address translation information 15 concerning the access target data exists in the memory management unit 12.

If an entry concerning the address of the access target data exists in the address translation information 15 of the memory management unit 12, in step T4, the memory management unit 12 refers to the entry of the access target data in the address translation information 15 and translates a logical address to a physical address.

If an entry concerning the address of the access target data does not exist in the address translation information 15 of the memory management unit 12, exception processing is executed in step T5.

When exception processing is executed, in step T6, the access control unit 14 loads the access target data from a device such as a secondary storage device 4, an external access device 5, or an I/O device 6 to the nonvolatile main memory 3 by software processing. The memory management unit 12 sets the entry after the load in the address translation information 15 and thus updates the address translation information 15. After that, the process advances to step T4.

In step T7 after step T4, the access control unit 14 reads out data stored at the position of the physical address of the nonvolatile main memory 3 and loads it to the cache memory 10. The access control unit 14 also directly feeds the readout data to the processor cores 91 to 94 if necessary.

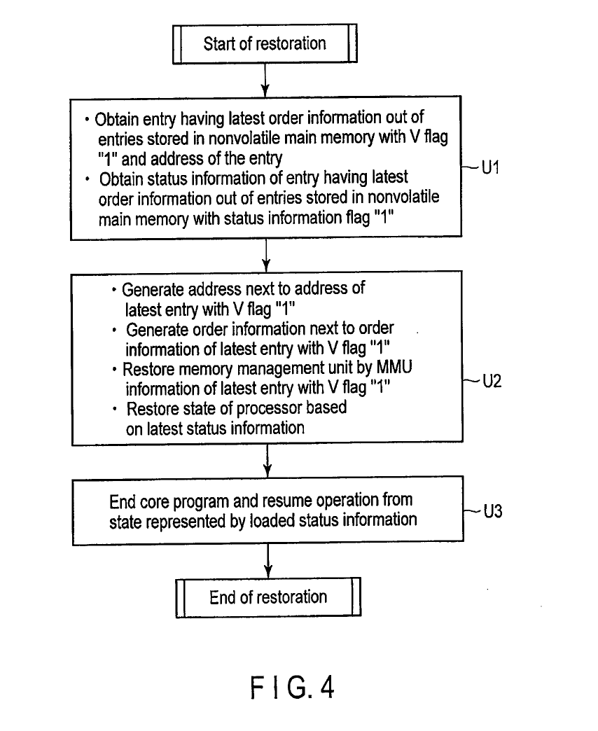

FIG. 4 is a flowchart showing an example of restoration processing (recovery) of the information processing device 1 according to this embodiment.

For example, when the information processing device 1 is powered on, the processor 2 reads out the core program 7 stored in the nonvolatile main memory 3 and executes the core program 7 to perform restoration. The core program 7 is executed by at least one of the processor cores 91 to 94. An example in which the processor core 91 executes the core program 7 will be described below.

In step U1, the processor core 91 that executes the core program 7 sequentially reads out the entries of the data portion 25 stored in the nonvolatile main memory 3.

The processor core 91 that executes the core program 7 obtains an entry having the latest order information 19 out of the entries whose V flags 20 are “1”, and obtains the address (latest address) of the latest entry. The processor core 91 that executes the core program 7 also obtains the status information 24 (latest status information) of the entry having the latest order information 19 and the MMU information 23 (latest MMU information) of the entry having the latest order information 19 out of the entries whose status information flags 22 are “1”.

In step U2, the processor core 91 that executes the core program 7 causes the address generation unit 16 to generate an address next to the address of the entry having the V flag 20 “1” and the latest order information 19.

The processor core 91 that executes the core program 7 causes the order generation unit 17 to generate order information next to the order information of the entry having the V flag 20 “1” and the latest order information 19.

The processor core 91 that executes the core program 7 restores the memory management unit 12 based on the MMU information 23 of the entry having the V flag 20 “1” and the latest order information 19.

The processor core 91 that executes the core program 7 loads the status information 24 corresponding to the status information flag 22 “1” and the latest order information 19 and restores the state of the processor 2 based on the loaded status information 24.

In step U3, the processor core 91 ends executing the core program 7 and resumes the operation from the state represented by the loaded status information 24.

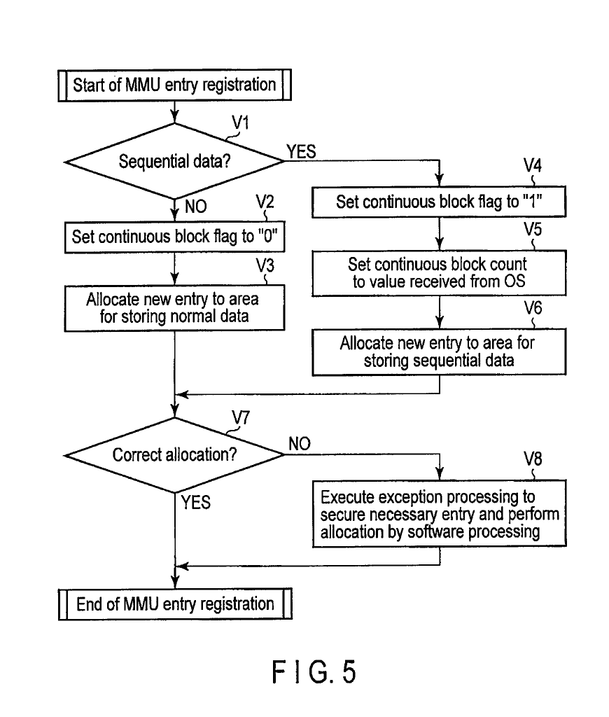

FIG. 5 is a flowchart showing an example of entry registration processing of the memory management unit 12 in the information processing device 1 according to this embodiment. In FIG. 5, an example will be explained in which the write target is normal data or sequential data. This also applies to a case in which the write target is a normal program or a sequential program.

In step V1, the memory management unit 12 determines, based on the determination result of the operating system 60, whether the write target data is sequential data.

If the write target data is not sequential data, the memory management unit 12 sets the continuous block flag 27 of a new entry of the address translation information 15 to “0” in step V2. In step V3, the memory management unit 12 allocates the new entry to an area of the nonvolatile main memory 3 to store normal data. After that, step V7 is executed.

If the write target data is sequential data, the memory management unit 12 sets the continuous block flag 27 of a new entry of the address translation information 15 to “1” in step V4. In step V5, the memory management unit 12 sets the continuous block count 28 received from the operating system 60 for the new entry of the address translation information 15. In step V6, the memory management unit 12 allocates the new entry to an area of the nonvolatile main memory 3 to store sequential data. After that, step V7 is executed.

In step V7, the memory management unit 12 determines whether a sufficient area secures, and allocation is done correctly.

If allocation is done correctly, the entry registration processing of the memory management unit 12 ends.

If allocation is not done correctly, in step V8, one of the processor cores executes exception processing by software. The memory management unit 12 secures and allocates a necessary entry. After that, the entry registration processing of the memory management unit 12 ends.

In this embodiment, the information processing device 1 may separate a normal data storage area to store normal data and a sequential data storage area to store sequential data.

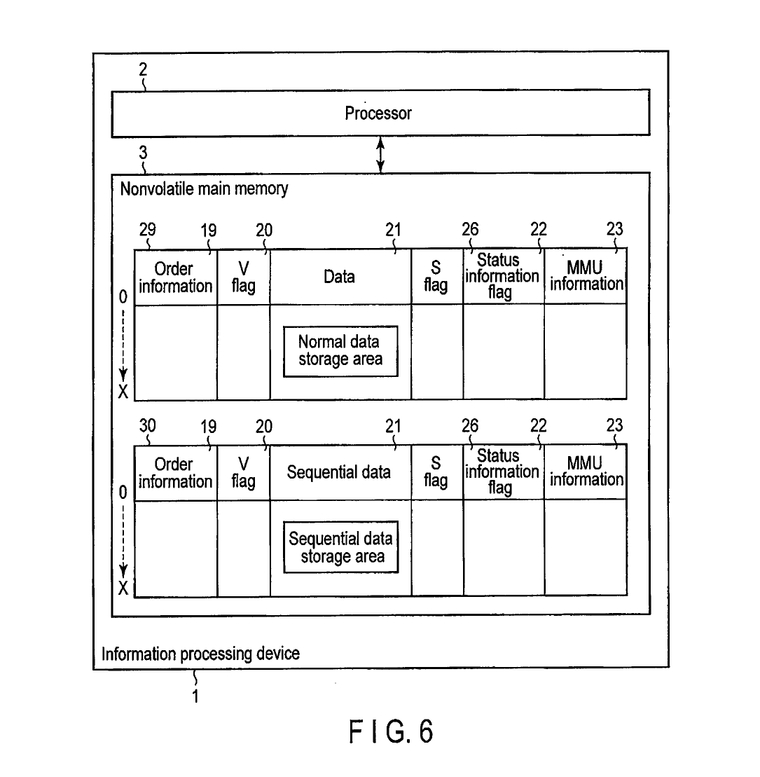

FIG. 6 is a block diagram showing an example of the information processing device 1 according to this embodiment in which the normal data storage area and the sequential data storage area are separated.

In the information processing device 1, the nonvolatile main memory 3 includes a normal data storage area 29 and a sequential data storage area 30. The normal data storage area 29 and the sequential data storage area 30 are separated or stored in different memory units.

For example, when an upper limit of an access count of the sequential data storage area 30 is smaller than an upper limit of an access count of the normal data storage area 29, out of sequential data, sequential data determined by the operating system 60 or the like to have a low write frequency may be stored in the sequential data storage area 30 with higher priority than sequential data having a high write frequency.

For example, the nonvolatile main memory 3 may be divided into an MLC (Multi Level Cell) area and an SLC (Single Level Cell) area. Sequential data having a large data size may preferentially be allocated to the MLC area having higher degree of integration than the SLC area, and normal data may preferentially be allocated to the SLC area having lower degree of integration than the MLC area.

For example, an SLC-type NAND flash memory and an MLC-type NAND flash memory are compared. The SLC-type NAND flash memory is faster in access and more reliable than the MLC-type NAND flash memory but is not suitable for increasing the capacity because of the low degree of element integration. On the other hand, the MLC-type NAND flash memory is slower in access and less reliable than the SLC-type NAND flash memory but is suitable for increasing the capacity because of the high degree of element integration.

Note that in this embodiment, durability means, for example, durability for write. Reliability means difficulty of data loss occurrence in data read.

In this embodiment, when sequential data is stream data, the rewrite count or frequency of the sequential data is supposed to be less than the rewrite count or frequency of normal data. For this reason, an area of the nonvolatile main memory 3 where the write count is closer to an upper limit of the write count (an area where the write count is tight) may be used as the sequential data storage area 30, and an area where the write count is much smaller than the upper limit of the write count may be used as the normal data storage area 29. For example, the operating system 60 compares the write count and the upper limit of the write count in each area of the nonvolatile main memory 3 and determines the normal data storage area 29 and the sequential data storage area 30.

Even in the sequential data storage area 30, an area where the write count is small (for example, an area where the write count is smaller than a predetermined number or has not more than a predetermined ratio to the upper limit of the write count) may be changed to the normal data storage area 29. Conversely, even in the normal data storage area 29, an area where the write count is large (for example, an area where the write count is equal to or larger than a predetermined number or has a predetermined ratio or more to the upper limit of the write count) may be changed to the sequential data storage area 30.

The effects of the information processing device 1 according to the above-described embodiment will be explained.

In this embodiment, when writing sequential data or a sequential program to the nonvolatile main memory 3, the sequential data or sequential program is continuously written on the block unit. This allows to improve the access efficiency of sequential data or sequential program to be continuously accessed.

Additionally, in this embodiment, sequential data or a sequential program is stored in a block area. The memory management unit 12 manages the address translation information 15 of the sequential data or sequential program on the block area unit. This enables to decrease the use amount of the address translation information of the memory management unit 12.

As described above, in this embodiment, it is possible to improve the access efficiency and management efficiency of sequential data.

In this embodiment, when managing access to the nonvolatile semiconductor memory, the operation can be speeded up, and high reliability can be implemented without complicating the hardware arrangement. Additionally, in this embodiment, the life of the nonvolatile semiconductor memory can be prolonged.

In a conventional information processing device, since a volatile memory is used as the main memory, the operating system 60, programs, and data need to be loaded at each reactivation time. In the information processing device 1 according to this embodiment, however, a nonvolatile semiconductor memory is used as the main memory. Since necessary programs and data are stored in the nonvolatile main memory 3 even at the time of reactivation, it is possible to reduce or obviate the need to boot the system and load programs and data and thus speed up the processing of the information processing device 1. That is, in the information processing device 1 according to this embodiment, a nonvolatile semiconductor memory is used as the main memory of the processor 2, and the progress of processing is written to the nonvolatile main memory 3, thereby enabling to hold the state of the information processing device 1 without any backup power supply. Furthermore, the information processing device 1 speeds up program activation.

In the information processing device 1 according to this embodiment, every time a generation event of the status information 24 occurs, the status information 24 is stored in the nonvolatile main memory 3. For this reason, even in case of abrupt power-off, the state of the processor 2 can be restored to the state before power-off by reading out the latest status information 24, and the operation of the information processing device 1 can be re-executed.

In this embodiment, the cache size of the cache memory 10, and “the write size of the nonvolatile main memory 3, or the write size of the data/program 21 or the status information 24” match each other or have an integer multiple relationship. This makes it possible to obviate the need to convert the data or program size between the cache memory 10 and the nonvolatile main memory 3, decrease the size conversion hardware amount, simplify control of the nonvolatile main memory 3, and raise the efficiency of processing of the information processing device 1.

In this embodiment, rate control of write back from the cache memory 10 may be performed if necessary. Each of the processor cores 91 to 94 may include a local memory but accesses the nonvolatile main memory 3 via the cache memory. This allows to increase the access speed.

In this embodiment, when, for example, a NAND flash memory, a NOR flash memory, or the like is used as the nonvolatile main memory 3, the nonvolatile main memory can be used as the main memory without performing conventional wear leveling.

### Second Embodiment

In this embodiment, a modification of the first embodiment will be described.

In this embodiment, a plurality of continuous block areas to store sequential data need not always be arranged continuously on an actual physical storage medium. The arrangement need only be efficient and effective for sequentially accessing or transferring data.

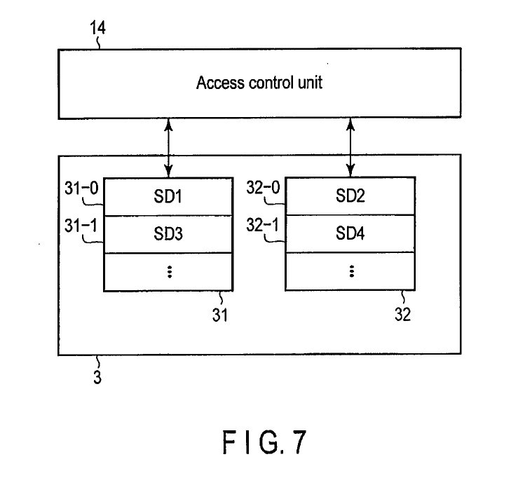

FIG. 7 is a block diagram showing an example of a nonvolatile main memory 3 including a plurality of memory units to be effectively accessed continuously.

The nonvolatile main memory 3 includes a plurality of memory units (memory chips) 31 and 32. In FIG. 7, an example will be described in which the number of block areas to store sequential data is 4, and the number of memory units is 2. The number of block areas to store sequential data and the number of memory units may be 2 or more.

When the nonvolatile main memory 3 includes the plurality of memory units 31 and 32, an access control unit 14 stores sequential data SD1 to SD4 while switching the memory units 31 and 32 of the storage target, instead of continuously storing the sequential data SD1 to SD4 in the same memory unit.

For example, the sequential data SD1 to SD4 are stored in a 0th block area 31-0 of the first memory unit 31, a 0th block area 32-0 of the second memory unit 32, a first block area 31-1 of the first memory unit 31, and a first block area 32-1 of the second memory unit 32 in this order. In this case, it is possible to access the 0th block area 32-0 of the second memory unit 32 while accessing the 0th block area 31-0 of the first memory unit 31. Since access to the 0th block area 32-0 of the second memory unit 32 can overlap (be parallelized to) access to the 0th block area 31-0 of the first memory unit 31, high-speed data access can be performed.

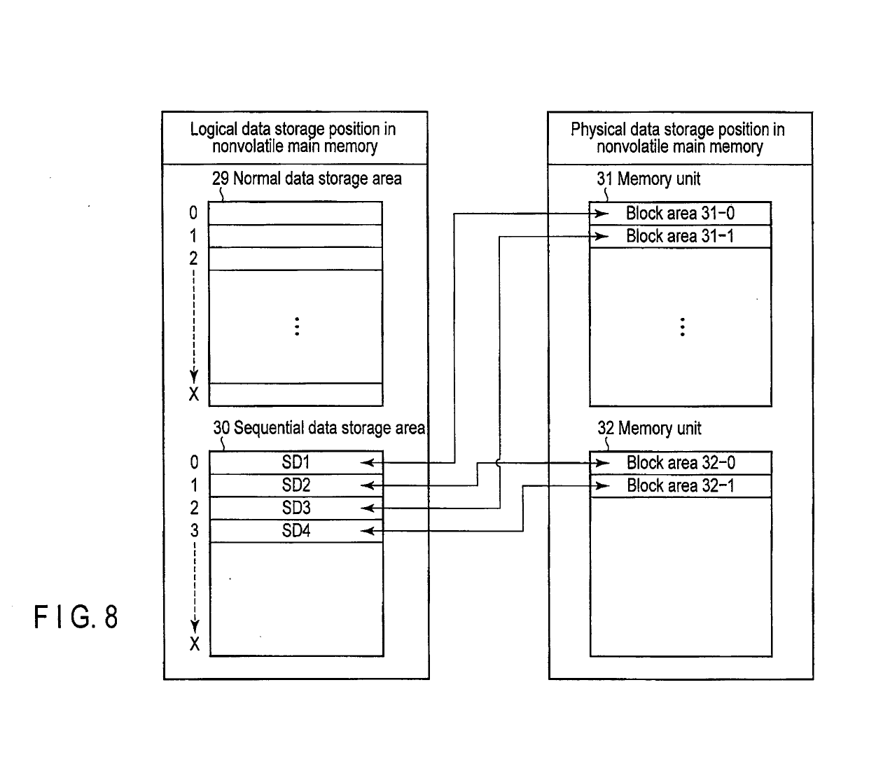

FIG. 8 is a block diagram showing a first example of a relationship between a logical data storage position and a physical data storage position in the nonvolatile main memory 3 according to this embodiment.

The sequential data SD1 to SD4 are stored in a sequential data storage area 30 in a logically continuing state. Physically, however, the sequential data SD1 to SD4 are stored while switching the memory units 31 and 32.

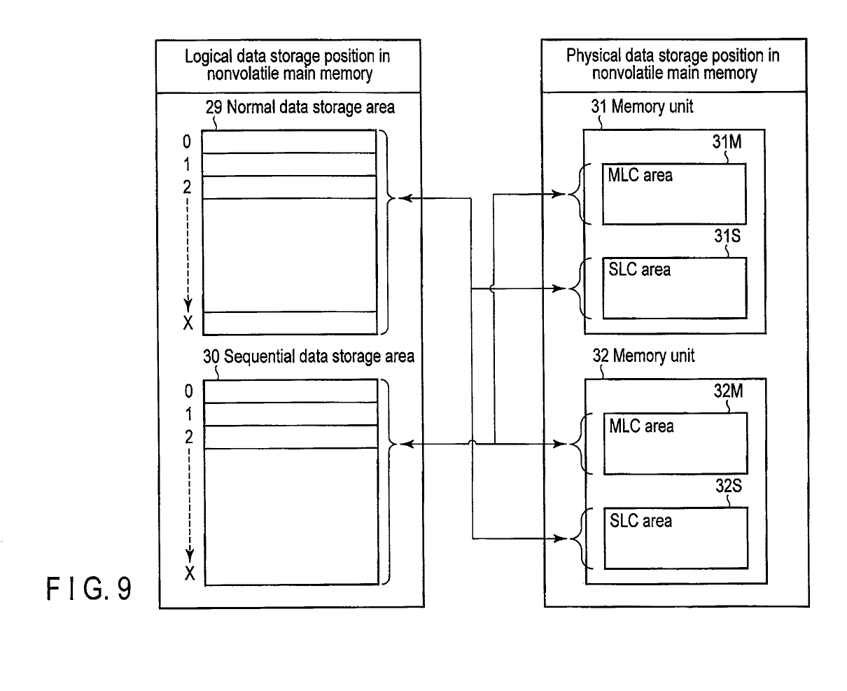

FIG. 9 is a block diagram showing a second example of the relationship between the logical data storage position and the physical data storage position in the nonvolatile main memory 3 according to this embodiment.

Referring to FIG. 9, the memory unit 31 includes an MLC area 31M and an SLC area 31S. The memory unit 32 includes an MLC area 32M and an SLC area 32S.

In the nonvolatile main memory 3, normal data is logically stored in a normal data storage area 29. Physically, however, the normal data is stored in the SLC areas 31S and 32S of the memory units 31 and 32.

Sequential data is logically stored in the sequential data storage area 30. Physically, however, the sequential data is stored in the MLC areas 31M and 32M of the memory units 31 and 32.

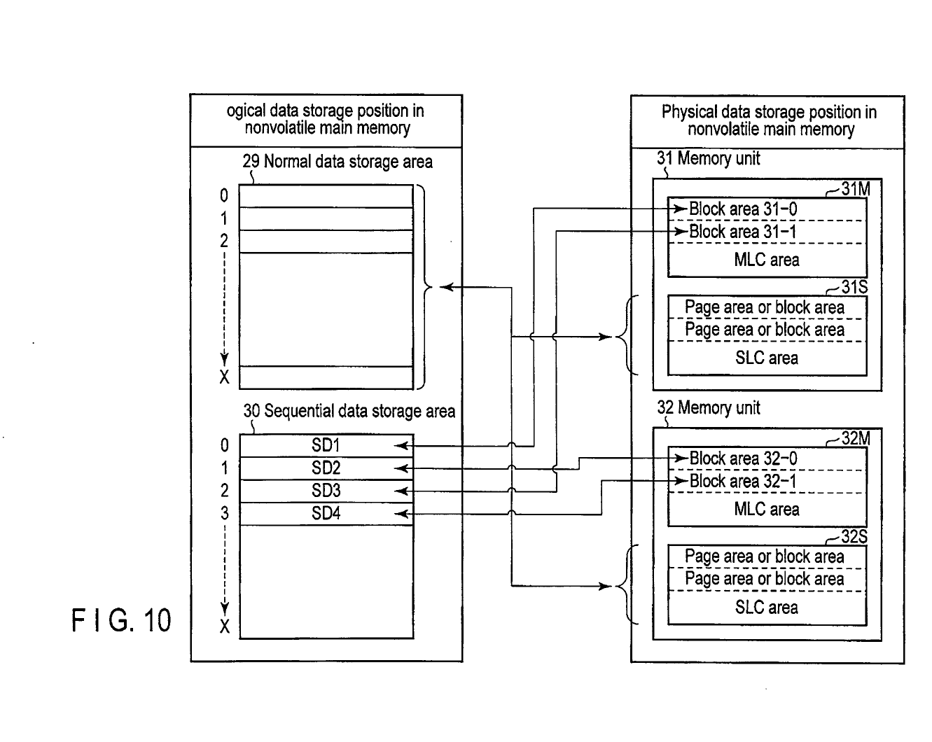

FIG. 10 is a block diagram showing a third example of the relationship between the logical data storage position and the physical data storage position in the nonvolatile main memory 3 according to this embodiment. The relationship shown in FIG. 10 is a combination of the above-described relationships in FIGS. 8 and 9.

In the nonvolatile main memory 3, normal data is logically stored in the normal data storage area 29. Physically, however, the normal data is stored in the SLC areas 31S and 32S of the memory units 31 and 32.

The sequential data SD1 to SD4 are stored in the sequential data storage area 30 in a logically continuing state. Physically, the sequential data SD1 to SD4 are stored in the block areas 31-0, 32-0, 31-1, and 32-1 in this order while switching the MLC areas 31M and 32M of the memory units 31 and 32.

In this embodiment, it is possible to parallelize and speed up access to sequential data.

### Third Embodiment

In this embodiment, a modification of the information processing device 1 according to the first and second embodiments in which cache memories form a hierarchical structure will be described.

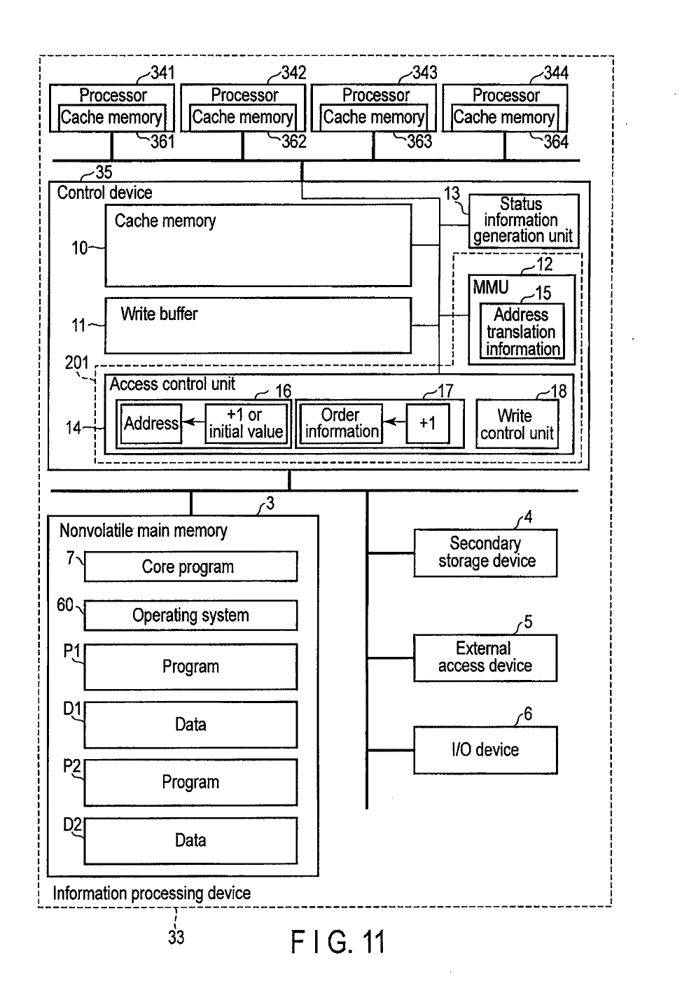

FIG. 11 is a block diagram showing an example of an arrangement of an information processing device according to this embodiment.

An information processing device 33 includes at least one or a plurality of (four, in the example of FIG. 11) processors 341 to 344, a control device 35, and the nonvolatile main memory 3.

The information processing device 33 includes a secondary storage device 4, an external access device 5, and an I/O device 6. The nonvolatile main memory 3 stores a core program 7 and an operating system 60. The processors 341 to 344 and the control device 35 execute the operating system 60. The processors 341 to 344 execute programs P1 and P2 while accessing data D1 and D2 in the nonvolatile main memory 3.

The processors 341 to 344 includes primary cache memories 361 to 364, respectively. When a cache miss occurs in the primary cache memories 361 to 364, the processors 341 to 344 send the address of the access target to the control device 35.

The control device 35 includes a secondary cache memory 10, a write buffer 11, a status information generation unit 13, and a memory management device 201 including an access control unit 14 and a memory management unit 12. Various kinds of processing such as write back, fetch, and restoration to be executed by the control device 35 are the same as in the above-described first embodiment.

In this embodiment, an example will be described in which the primary cache memories 361 to 364 and the secondary cache memory 10 form a two-layered structure. However, the control device 35 is similarly applicable even when the number of layers of cache memories is three or more.

In this embodiment, the processors 341 to 344 access the nonvolatile main memory 3 via the primary cache memories 361 to 364 and the secondary cache memory 10. This allows to speed up access processing of the processors 341 to 344.

### Fourth Embodiment

In this embodiment, a case will be described in which each information processing device according to the first to third embodiments is provided with a write count check unit and an abnormality detection unit. In this embodiment, a case will be explained in which the information processing device 1 according to the above-described first embodiment is provided with a write count check unit and an abnormality detection unit. However, the embodiment is similarly applicable to an information processing device of another form such as the information processing device according to the second or third embodiment.

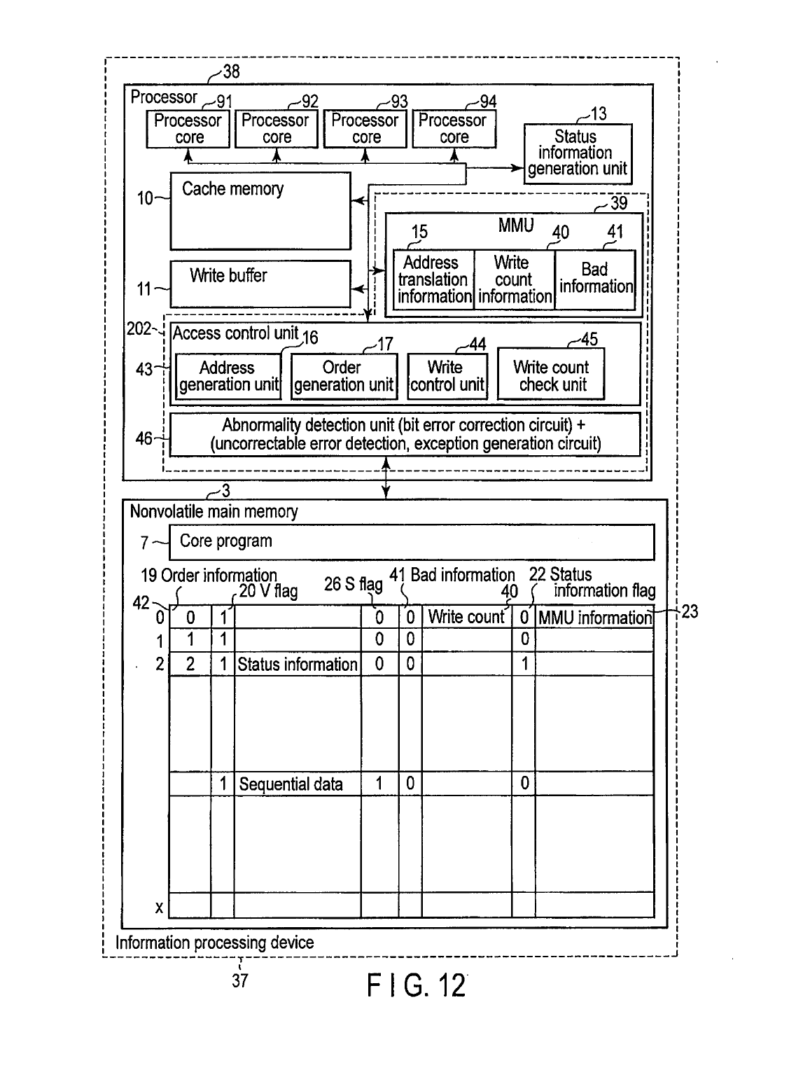

FIG. 12 is a block diagram showing an example of an arrangement of an information processing device according to this embodiment.

A processor 38 of an information processing device 37 according to this embodiment includes a memory management device 202. The memory management device 202 includes a memory management unit 39, an access control unit 43, and an abnormality detection unit 46.

The memory management unit 39 according to this embodiment includes write count information 40 representing the write count and Bad information 41 for each area (for example, an address area or a block area) of the nonvolatile main memory 3 in addition to address translation information 15.

The Bad information 41 has a value representing abnormality for each area of the nonvolatile main memory 3 when the write count represented by the write count information 40 exceeds the upper limit. Note that the Bad information 41 is stored in a data portion 42 of the nonvolatile main memory 3 as well.

In this embodiment, the memory management unit 39 updates the write count information 40 at the timing of write to the nonvolatile main memory 3 (the write count for the write target area or entry is incremented by one).

A write control unit 44 of the access control unit 43 stores the write count information 40 in an area of interest of the nonvolatile main memory 3 in correspondence with order information 19.

The access control unit 43 includes a write count check unit 45. The write count check unit 45 checks the write count in the write destination area at the time of write to the nonvolatile main memory 3 and generates exception processing when the write count is larger than a predetermined value representing the upper limit or has a predetermined ratio to the upper limit. In the exception processing, software is activated, and necessary processing is executed by the software.

For example, in the exception processing by the software, a value representing abnormality is set, in the memory management unit 39 and the nonvolatile main memory 3, for the Bad information 41 of the entry of an area where the write count exceeds the upper limit so as not to perform write to the entry where the write count exceeds the upper limit. The memory management unit 39 prohibits write to the entry having the Bad information 41 representing abnormality.

In the information processing device 37 according to this embodiment, the processor 38 includes the abnormality detection unit 46. For example, an ECC circuit or the like is used as the abnormality detection unit 46. The abnormality detection unit 46 performs bit error correction, uncorrectable error detection, and exception generation.

The above-described write count check unit 45 prohibits use when the write count exceeds the upper limit. However, a bit error may occur even before the write count exceeds the upper limit.

To cope with such an error, the abnormality detection unit 46 performs bit error detection in the nonvolatile main memory 3. In addition, the abnormality detection unit 46 corrects an occurred bit error if it is correctable. When an uncorrectable bit error occurs, the abnormality detection unit 46 generates exception processing to perform necessary processing by software. For example, in the exception processing by the software, a value representing abnormality is set, in the memory management unit 39 and the nonvolatile main memory 3, for the Bad information 41 of the entry of an area where the uncorrectable error occurs so as not to perform write to the entry where the uncorrectable error occurs. The memory management unit 39 prohibits write to the entry having the Bad information 41 representing abnormality.

In the above-described embodiment, when abnormality occurs in write to the nonvolatile main memory 3, appropriate processing of, for example, prohibiting use of the area where the abnormality occurs or instructing a user to replace can be performed by software.

In each of the above-described embodiments, rate control of write back from the cache memory may be performed.

### Fifth Embodiment

In each of the above-described embodiments, the storage area of the nonvolatile main memory 3 may be separated in accordance with the type of contents to be written such as a program, data, or status information.

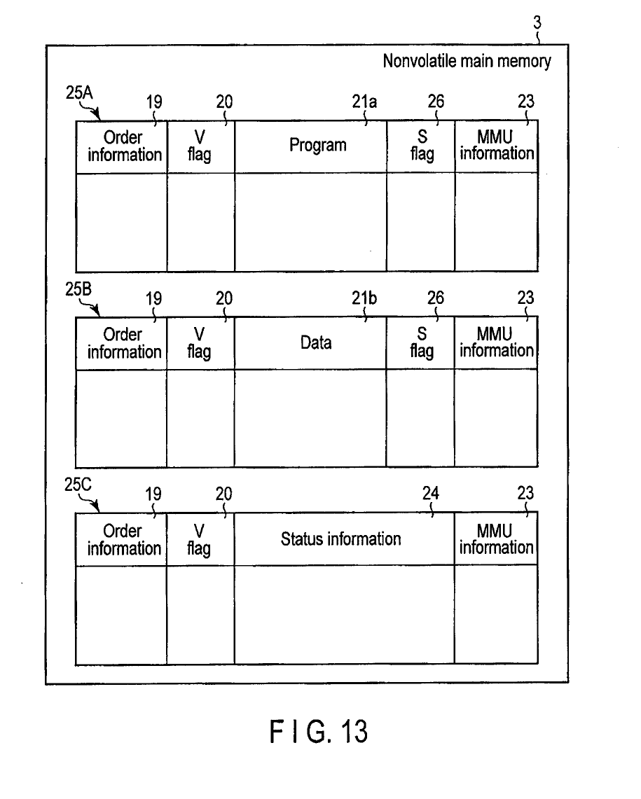

FIG. 13 is a block diagram showing an example of a nonvolatile main memory 3 which stores a program, data, and status information separately in a plurality of data portions (storage areas).

An address generation unit 16 of an access control unit 14 or 43 determines which one of a program 21a, data 21b, and status information 24 is to be written. If the program 21a is to be written, the address generation unit 16 generates an address to store the write target program 21a in a data portion (storage area) 25A. If the data 21b is to be written, the access control unit 14 or 43 generates an address to store the write target data 21b in a data portion (area) 25B. If the status information 24 is to be written, the access control unit 14 or 43 generates an address to store the write target status information 24 in a data portion (area) 25C. Order information 19, a V flag 20, and MMU information 23 are associated with each of the written contents.

An S flag 26 is associated with each of the contents written in the data portions 25A and 25B.

Note that the MMU information 23 may also be stored in another storage area.

### Sixth Embodiment

In this embodiment, a modification of the first to fifth embodiments will be described. Note that a modification of the first embodiment will be described below. However, this also applies to modifications of the second to fifth embodiments.

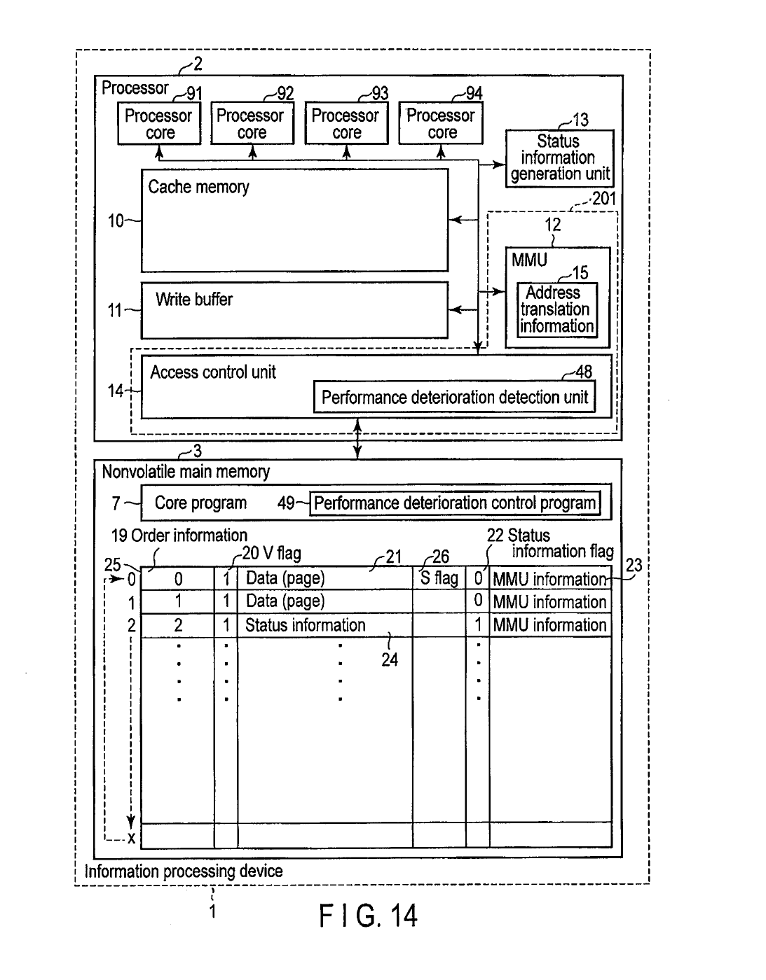

FIG. 14 is a block diagram showing an example of an arrangement of an information processing device according to this embodiment.

An access control unit 14 of a memory management device 201 also includes a performance deterioration detection unit 48.

The core program 7 includes a performance deterioration suppressing program 49.

When the number of writable areas (the number of writable entries) decreases in a nonvolatile main memory 3, performance of access to the nonvolatile main memory 3 may deteriorate. When no writable area remains, processing cannot be continued.

The performance deterioration detection unit 48 detects whether performance deterioration occurs in access from the processor 2 to the nonvolatile main memory 3 in the information processing device 1. For example, the performance deterioration detection unit 48 detects occurrence of performance deterioration when a time to search for a write area exceeds a set value, the number of writable entries becomes equal to or less than a set value or set ratio, or a combination of the two conditions occurs.

Upon detecting that performance deterioration occurs in access from the processor 2 to the nonvolatile main memory 3, the performance deterioration detection unit 48 generates an exception to the processor 2.

When the exception command generates, the processor 2 executes the performance deterioration suppressing program 49 in the core program 7.

In accordance with the performance deterioration suppressing program 49, the processor 2 executes processing such as garbage collection to suppress performance deterioration.

The performance deterioration suppressing program 49 executes various kinds of processing of, for example, searching the current nonvolatile main memory 3 and integrating some of the plurality of entries that can be integrated, collecting and rearranging only valid data when valid data and unused data (erased data) are mixed in the nonvolatile main memory 3, and increasing free areas by moving data of low access frequency, data of low importance or priority, and data of low use frequency to another storage medium, or a combination of the various kinds of processing.

In the above-described embodiment, it is possible to prevent the performance of the information processing device 1 from deteriorating because of, for example, a decrease in the number of writable areas.

Executing the processing of the performance deterioration suppressing program 49 in parallel to normal processing allows to minimize an influence on normal processing.

When a dedicated processor for executing the processing of the performance deterioration suppressing program 49 is provided, the capability of the processor 2 can be prevented from lowering due to exception processing.

Control of each of the above-described embodiments is also applicable when the nonvolatile semiconductor memory is used for a purpose other than the main memory.

### Seventh Embodiment

In the above-described embodiments, the nonvolatile main memory 3 is used as the main memory.

However, a hybrid memory including different types of semiconductor memories having different properties may be used as the main memory in place of the nonvolatile main memory 3 in the above-described embodiments.

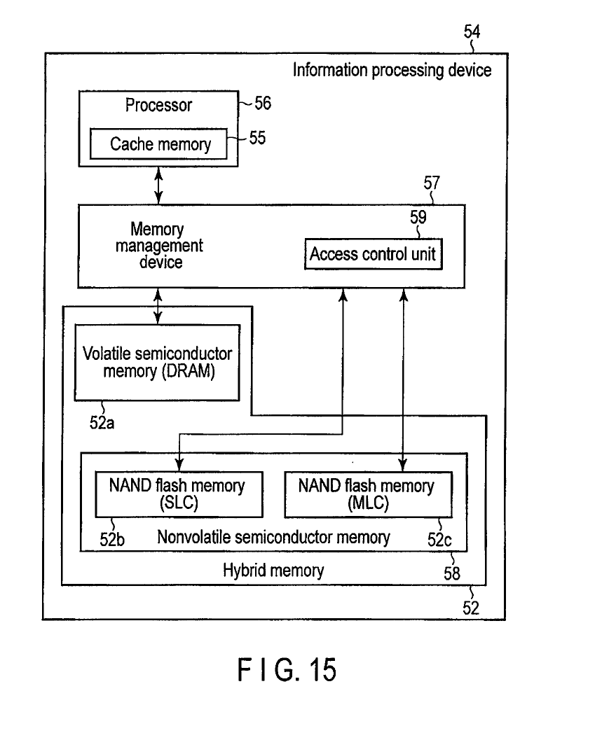

FIG. 15 is a block diagram showing an example of an information processing device according to this embodiment including a hybrid memory.

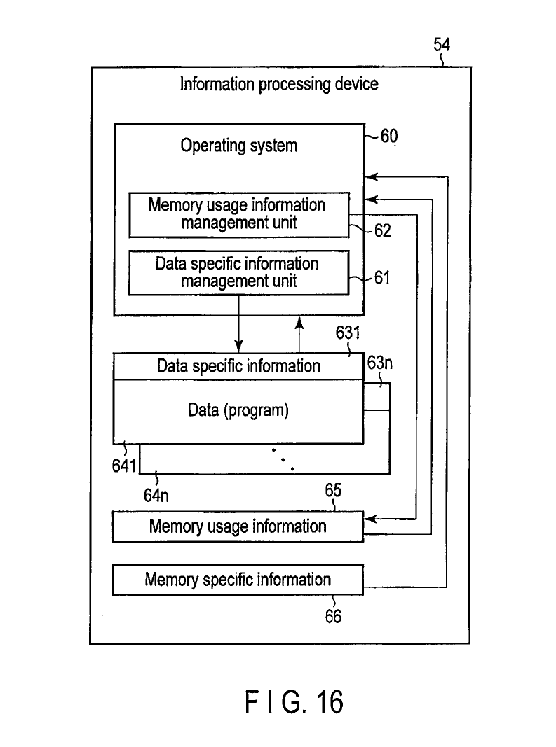

FIG. 16 is a block diagram showing an example of a program and data used in the information processing device according to this embodiment.

An information processing device 54 includes at least one processor 56 including a cache memory 55, a memory management device 57, and a hybrid memory 52.

The processor 56 is connected to the hybrid memory 52 via the memory management device 57. The memory management device 57 includes an access control unit 59 including the same functions as the functions of, for example, the access control units 14 or 43 according to the above-described embodiments. The memory management device 57 also includes the functions of the memory management units 12 or 39. In this embodiment, the memory management device 57 includes an address generation unit 16, an order generation unit 17, and a write control unit 18.

The hybrid memory 52 is formed by combining a plurality of types of semiconductor memories. In this embodiment, the hybrid memory 52 includes, for example, a volatile semiconductor memory 52a and a nonvolatile semiconductor memory 58. The nonvolatile semiconductor memory 58 includes nonvolatile semiconductor memories 52b and 52c.

For example, a DRAM is used as the volatile semiconductor memory 52a. However, an FPM-DRAM (Fast Page Mode Dynamic Random Access Memory), an EDO-DRAM (Extended Data Out Dynamic Random Access Memory), an SDRAM (Synchronous Dynamic Random Access Memory), or the like may be used in place of the DRAM. A nonvolatile random access memory such as an MRAM (Magnetoresistive Random Access Memory) or an FeRAM (Ferroelectric Random Access Memory) may be employed in place of the volatile semiconductor memory 52a if the memory is capable of high-speed random access of DRAM level and virtually has no upper limit for the access count.

The nonvolatile semiconductor memory 52b is, for example, an SLC-type NAND flash memory. The nonvolatile semiconductor memory 52c is, for example, an MLC-type NAND flash memory.

Note that another nonvolatile semiconductor memory may be used as the nonvolatile semiconductor memories 52b and 52c in place of the NAND flash memory.

In this embodiment, the volatile semiconductor memory 52a has a high reliability or a high durable and has a larger upper limit for the access count as compared to the nonvolatile semiconductor memory 52b. The nonvolatile semiconductor memory 52b has a high reliability or a high durable and has a larger upper limit for the access count as compared to the nonvolatile semiconductor memory 52c.

The address generation unit 16 of the access control unit 59 selects the write destination memory in the hybrid memory 52 such that the access count or access frequency of the volatile semiconductor memory 52a is more than the access count or access frequency of the nonvolatile semiconductor memory 52b, and the access count or access frequency of the nonvolatile semiconductor memory 52b is more than the access count or access frequency of the nonvolatile semiconductor memory 52c.

As described above, the write destination memory is selected by the address generation unit 16 based on information such as the access count, the access frequency, or the importance of write target data.

The access frequency is a value representing the frequency of access occurrence. The access frequency is determined based on, for example, a process priority, file format information, access pattern, segments of the ELF format, or the like. For example, the write frequency of data concerning a media file is set to be low. For example, for a permission for which the access pattern is designated by a system call, the access frequency is set to be high. For a permission for which the access pattern is a file, the access frequency is set to be low. For example, the write frequency out of the access frequency for a segment formed by a read only section is set to be low. There are two types of access frequencies: a static access frequency whose value remains unchanged and a dynamic access frequency whose value changes in accordance with the access state. The dynamic access frequency is a value obtained based on the access count of data to effectively arrange the data. As the dynamic access frequency, for example, a value calculated based on the access count and information about time can be used. For example, the dynamic access frequency may be an access count per unit time.

The importance is a value representing the degree of importance of data. There are two types of importance: a static importance whose value remains unchanged and a dynamic importance whose value changes in accordance with the access state. The static importance is determined based on, for example, a data type (file format) or setting information set by a user. The dynamic importance is determined based on an access time or the like. For example, for data concerning an executable file, the static importance is set to be high. For example, for data concerning a media file, the static importance is set to be medium level. For example, when a folder storing a file is a recycle bin or a mail box, the static importance is set to be low for data concerning the file. For example, the dynamic importance of write target data is set to decrease in proportion to the interval from the final access time to the current time.

The information processing device 54 executes an operating system 60. The operating system 60 includes a data specific information management unit 61 and a memory usage information management unit 62.

The information processing device 54 causes the data specific information management unit 61 of the operating system 60 to manage pieces of data specific information 631 to 63n.

The pieces of data specific information 631 to 63n include, for data (or programs) 641 to 64n, for example, at least one piece of data specific information out of the access frequency, the access count, and the importance.

That is, the pieces of data specific information 631 to 63n for the data 641 to 64n are associated with the data 641 to 64n handled by the information processing device 54. The pieces of data specific information 631 to 63n include the access frequencies of the data 641 to 64n, respectively. When write or read for the data 641 to 64n occurs, the data specific information management unit 61 updates the pieces of data specific information 631 to 63n of the data 641 to 64n.

Note that the pieces of data specific information 631 to 63n may be managed in a state separated from the data 641 to 64n.

The information processing device 54 causes the memory usage information management unit 62 of the operating system 60 to manage memory usage information 65.

The memory usage information 65 includes information representing the use states of the memories 52a to 52c, for example, the use amounts or use ratios of the memories 52a to 52c and the use amounts or use ratios of areas of the memories 52a to 52c. For example, the memory usage information 65 includes the “access count/upper limit of access count” of each of the memories 52a to 52c, the “access count/upper limit of access count” of each area of the memories 52a to 52c, the “used capacity/total capacity” of each of the memories 52a to 52c, the access count and access frequency of each area of the memories 52a to 52c, and the like. For example, when access to the hybrid memory 52 is executed, the memory usage information management unit 62 updates the information such as the use amount or use ratio of the accessed memory, the use amount or use ratio of the accessed area, the access count, and the access frequency in the memory usage information 65. In this embodiment, the memory usage information 65 may include the write count information 40 of the above-described fourth embodiment.

The information processing device 54 manages memory specific information 66 by using the operating system 60.

The memory specific information 66 includes information specific to each memory, for example, the upper limit of the access count (life information or durability information) of each of the memories 52a to 52c of the hybrid memory 52.

For example, the address generation unit 16 of the access control unit 59 obtains the access count, the access frequency, and the importance of write target data based on the data specific information 631 to 63n and information representing a relationship between data and a file managed by the operating system 60, and calculates the evaluation value of the write target data based on the access count, the access frequency, and the importance of the write target data. The larger the access count, the access frequency, and the importance are, the larger the evaluation value is. The address generation unit 16 selects the write destination memory based on the evaluation value of the write target data, the memory usage information 65, the memory specific information 66, and a memory selection threshold used to select a memory. For data having a larger evaluation value, the address generation unit 16 selects the volatile semiconductor memory 52a with higher priority over the nonvolatile semiconductor memory 52b and the nonvolatile semiconductor memory 52b with higher priority over the nonvolatile semiconductor memory 52c. Note that in this embodiment, the memory selection threshold may be preset as one element of the memory specific information 66 or dynamically calculated based on the memory usage information 65 and the like.

The address generation unit 16 generates an address to do write by the additional method described in the first to sixth embodiments for a memory selected from the plurality of memories in the hybrid memory 52.

Selection of the memories 52a to 52c by the memory management device 57 will be described in more detail.

When writing the data 641, the memory management device 57 checks the data specific information 631, the memory usage information 65, and the memory specific information 66 of the write target data 641, and selects a memory having sufficient write durability from the volatile semiconductor memory 52a, the nonvolatile semiconductor memory 52b, and the nonvolatile semiconductor memory 52c as the write destination memory. This selection makes it possible to use an inexpensive memory having high performance and large capacity for a long time.

For example, based on the data specific information 631 of the write target data 641, the memory management device 57 selects the SLC-type nonvolatile semiconductor memory 52b having high durability as the write destination when the access frequency of the write target data 641 is high. When the access frequency of the write target data 641 is low, the memory management device 57 selects the MLC-type nonvolatile semiconductor memory 52c having low durability as the write destination. This allows to optimize the cost, performance, access speed, and life of the hybrid memory 52.

For example, when the write target data 641 is stream data, the access control unit 59 of the memory management device 57 selects, for example, the MLC-type NAND flash memory 52c as the write destination of the stream data to store it. Since the write frequency of stream data tends to be low, sufficient memory performance can be ensured even when the MLC-type NAND flash memory 52c is used as the write destination.

When one of the SLC-type nonvolatile semiconductor memory 52b and the MLC-type nonvolatile semiconductor memory 52c is selected, the access control unit 59 of the memory management device 57 sequentially issues an address and, when the issued address indicates an unused area, executes a write operation by the additional method to store the write target data 641 in the unused area, as described in the above embodiments. This allows to implement smoothing of the access counts in the nonvolatile semiconductor memories 52b and 52c.

The memory selection threshold used by the memory management device 57 will be described in more detail.

In this embodiment, the write destination memory is selected from the different types of memories 52a to 52c in the hybrid memory 52 based on the memory selection threshold and the evaluation value calculated based on the access count, the access frequency, and the importance. For example, the memory selection threshold changes depending on the memory use ratio.

The use ratio may be either “access count/upper limit of access count” or “capacity of memory used areas/total memory capacity”.

The operating system 60 determines a first memory selection threshold to more easily select the nonvolatile semiconductor memory 52b rather than the volatile semiconductor memory 52a as the write destination as the use ratio of the volatile semiconductor memory 52a becomes higher.

The operating system 60 determines a second memory selection threshold to more easily select the nonvolatile semiconductor memory 52c rather than the nonvolatile semiconductor memory 52b as the write destination as the use ratio of the nonvolatile semiconductor memory 52b becomes higher.

The operating system 60 and the memory management device 57 select the write destination memory based on the evaluation value and a magnitude relationship between the first memory selection threshold and the second memory selection threshold.

Control of this embodiment is also applicable when the hybrid memory 52 is used for a purpose other than the main memory.

In the above-described embodiment, the volatile semiconductor memory 52a, the SLC-type nonvolatile semiconductor memory 52b, and the MLC-type nonvolatile semiconductor memory 52c are selectively used based on the access count, the access frequency, and the importance of data. This makes it possible to reduce the cost, increase the storage capacity, and prolong the life of the main memory used in the information processing device 54.

The hybrid memory 52 includes the nonvolatile semiconductor memories 52b and 52c that are inexpensive and have a larger capacity as compared to the volatile semiconductor memory 52a. For this reason, an inexpensive memory having a large capacity can be implemented as compared to a case in which only the volatile semiconductor memory 52a is simply used as the main memory.

In this embodiment, performing write by the additional method after memory selection enables to simplify the hardware resources.

The constituent elements described in the above embodiments can be combined or divided freely. For example, the access control unit 14 or 43 and the memory management unit 12 or 39 may be combined. For example, the functions of the memory management unit 12, the status information generation unit 13, and the access control unit 14 or 43 may be implemented by at least one of the processor cores 91 to 94. The function of the operating system 60 to determine whether data is sequential data may be implemented by hardware such as the access control unit 14. The address generation unit 16, the order generation unit 17, and the write control unit 18 can freely be combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory management device comprising:
a determination unit that, when data to be written from a processor to a nonvolatile semiconductor memory generates, determines whether the data is sequential data to be sequentially accessed or normal data that is not the sequential data;
an address generation unit that, when the determination unit determines that the data is the normal data, generates a first write address not to make a write position of the normal data overlap a position indicated by a generated address, and, when the determination unit determines that the data is the sequential data, generates a second write address representing a write position to sequentially store the sequential data;
an order generation unit that generates order information representing a degree of newness of write that occurs; and
a write control unit that, when the address generation unit generates the first write address, writes the normal data at the first write address in correspondence with the order information generated by the order generation unit, and when the address generation unit generates the second write address, sequentially writes the sequential data at the second write address.

2. The memory management device according to claim 1, wherein the address generation unit generates the second write address to store a start of the sequential data at a start of at least one block area to store the sequential data.

3. The memory management device according to claim 1, further comprising a memory management unit that manages a logical address and a physical address for the sequential data and a flag representing that the data is the sequential data in association with each other.

4. The memory management device according to claim 3, wherein the memory management unit further manages the logical address and the physical address for the sequential data and a continuous count of the sequential data in association with each other.

5. The memory management device according to claim 1, wherein the write control unit writes the sequential data to the nonvolatile semiconductor memory in association with a flag representing that the data is the sequential data.

6. The memory management device according to claim 1, wherein the address generation unit sequentially generates an address when write of the normal data from the processor to the nonvolatile semiconductor memory occurs, the address generation unit selects the generated address as the first write address when the generated address is unused, and the address generation unit performs address generation again from an initial value when the generated address reaches a predetermined value.

7. The memory management device according to claim 1, wherein
the write control unit writes status information generated by a status information generation unit in the processor to the nonvolatile semiconductor memory in correspondence with the order information generated by the order generation unit, and
the memory management device further comprises a restoration unit that, when restoring the processor, reads out latest status information from the nonvolatile semiconductor memory based on the order information and restore the processor using the latest status information.

8. The memory management device according to claim 7, wherein the restoration unit is implemented by causing the processor to execute a program stored in the nonvolatile semiconductor memory.

9. The memory management device according to claim 1, wherein
the write control unit writes memory management information managed by a memory management unit to the nonvolatile semiconductor memory in correspondence with the order information generated by the order generation unit, and
the memory management device further comprises a restoration unit that, when restoring the processor, reads out latest memory management information from the nonvolatile semiconductor memory based on the order information and restore the processor using the latest memory management information.

10. The memory management device according to claim 1, wherein
the write control unit manages write count information concerning an area of the nonvolatile semiconductor memory, and
the memory management device further comprises a write count check unit that prohibits write to an area where a write count represented by the write count information exceeds a threshold.

11. The memory management device according to claim 1, further comprising an abnormality detection unit that detects an error in the nonvolatile semiconductor memory, corrects the error when error correction is possible, and prohibits write to an area where the error occurs when error correction is impossible.

12. The memory management device according to claim 1, wherein
the nonvolatile semiconductor memory includes a plurality of types of areas, and
the address generation unit selects an area corresponding to a type of the data from the plurality of types of areas of the nonvolatile semiconductor memory and selects a write address in the selected area.

13. The memory management device according to claim 1, further comprising:
a detection unit that detects performance deterioration in access from the processor to the nonvolatile semiconductor memory; and
a performance deterioration suppressing unit that executes garbage collection processing when the detection unit detects performance deterioration.

14. The memory management device according to claim 1, wherein
the memory management device manages access to a hybrid memory including the nonvolatile semiconductor memory and another semiconductor memory of a type different from the nonvolatile semiconductor memory, and
the address generation unit selects a storage destination memory out of the nonvolatile semiconductor memory and the other semiconductor memory included in the hybrid memory such that one of an access count and an access frequency to a first memory having high reliability or durability exceeds a corresponding one of an access count and an access frequency to a second memory having low reliability or durability.

15. A memory management method comprising:
determining, when data to be written from a processor to a nonvolatile semiconductor memory generates, whether the data is sequential data to be sequentially accessed or normal data that is not the sequential data, by a memory management device;
generating, upon determining that the data is the normal data, a first write address not to make a write position of the normal data overlap a position indicated by a generated address, and generating, upon determining that the data is the sequential data, second write address representing a write position to sequentially store the sequential data, by the memory management device;
generating order information representing a degree of newness of write that occurs, by the memory management device; and
writing, when the first write address generates, the normal data at the first write address in correspondence with the generated order information, and sequentially writing, when the second write address has been generated, the sequential data at the second write address, by the memory management device.

16. The memory management method according to claim 15, wherein the generating the second write address comprises generating the second write address to store a start of the sequential data at a start of at least one block area to store the sequential data.

17. The memory management method according to claim 15, further comprising, by the memory management device, managing a logical address and a physical address for the sequential data and a flag representing that the data is the sequential data in association with each other.

18. The memory management method according to claim 17, further comprising, by the memory management device, managing the logical address and the physical address for the sequential data and a continuous count of the sequential data in association with each other.

19. The memory management method according to claim 15, wherein when writing the sequential data to the nonvolatile semiconductor memory, the sequential data is written in association with a flag representing that the data is the sequential data.

20. The memory management method according to claim 15, wherein the generating the first write address comprises sequentially generating an address when write of the normal data from the processor to the nonvolatile semiconductor memory occurs, selecting the generated address as the first write address when the generated address is unused, and performing address generation again from an initial value when the generated address reaches a predetermined value.
